(19) United States
(12) Patent Application Publication
(10) Pub. No.: US 2012/0105139 A1
(43) Pub. Date: May 3, 2012

(54) INTEGRATED CIRCUIT

(76) Inventor: Young-Han JEONG, Gyeonggi-do (KR)

(21) Appl. No.: 12/982,731

(22) Filed: Dec. 30, 2010

(30) Foreign Application Priority Data
Oct. 29, 2010 (KR) 10-2010-0107170

(51) Int. Cl. G05F 1/10

(52) U.S. Cl. 327/538

(57) ABSTRACT

An integrated circuit includes a first driving unit configured to drive an output terminal to a first power supply voltage in response to an active mode signal, a second driving unit configured to drive the output terminal to a second power supply voltage in response to a standby mode signal, and a current control unit configured to control the current path between the first driving unit and the first power supply voltage terminal in response to a mode control signal denoting the active mode signal and the standby mode signal.

### CROSS-REFERENCE TO RELATED APPLICATION

The present application claims priority of Korean Patent Application No. 10-2010-0107170, filed on Oct. 29, 2010, which is incorporated herein by reference in its entirety.

### BACKGROUND OF THE INVENTION

Exemplary embodiments of the present invention relate to semiconductor design technology, and more particularly, to an integrated circuit for generating a mode control signal that maintains a predetermined voltage level according to an active mode and a standby mode.

In general, semiconductor devices such as Double Data Rate Synchronous DRAM (DDR SDRAM) include internal circuits for performing various internal operations, and the internal circuits operate in an active mode or a standby mode. Thus, the semiconductor device includes an integrated circuit for generating a mode control signal corresponding to an active mode or a standby mode, and the internal circuit operates in an active mode or a standby mode in response to the mode control signal generated by the integrated circuit.

FIG. 1 is a circuit diagram illustrating a known integrated circuit for generating a mode control signal.

Referring to FIG. 1, an integrated circuit includes a plurality of signal driving units 110, 120, 130 and 140. Hereinafter, for the sake of convenience, the signal driving unit 110 among the signal driving units 110, 120, 130 and 140 will be representatively described.

The signal driving unit 110 includes a first PMOS transistor P1 and a second NMOS transistor N1 for driving a node A in response to an input signal CTR_IN. Herein, the input signal CTR_IN has a logic level corresponding to an active mode or a standby mode. For example, the input signal CTR_IN maintains a logic high level in an active mode and maintains a logic low level in a standby mode.

Hereinafter, circuit operations according to an active mode and a standby mode will be described in detail.

In the active mode, the input signal CTR_IN has a logic high level. Accordingly, the first NMOS transistor N1 is turned on, and the node A is driven to a ground voltage VSS. A second PMOS transistor P2 is turned on by the node A driven to the ground voltage VSS, and as a result, a node B is driven to a power supply voltage VDD. Consequently, an output signal CTR_OUT has a logic level corresponding to the logic high level of the input signal CTR_IN.

In the standby mode, the input signal CTR_IN has a logic low level. Accordingly, the first PMOS transistor P1 is turned on, and the node A is driven to the power supply voltage VDD. A second NMOS transistor N2 is turned on by the node A driven to the power supply voltage VDD, and as a result, the node B is driven to the ground voltage VSS. Consequently, the output signal CTR_OUT has a logic level corresponding to the logic low level of the input signal CTR_IN.

In the standby mode, the first NMOS transistor N1 and the second PMOS transistor P2 are turned off. However, an off-current flows in the first NMOS transistor N1 due to the voltage difference between the ground voltage (VSS) terminal and the node A driven to the power supply voltage VDD. Likewise, an off-current flows in the second PMOS transistor P2 due to the voltage difference between the power supply voltage (VDD) terminal and the node B driven to the ground voltage VSS. In general, an operational power is mostly consumed in an active mode, and an operational consuming power should be minimized in a standby mode. However, in the case of the known integrated circuit configured as illustrated in FIG. 1, an off-current may flow in a turned-off transistor during the standby mode so that the operational consuming power in the standby mode may not be minimized.

### SUMMARY OF THE INVENTION

Exemplary embodiments of the present invention are directed to an integrated circuit that can prevent an off current by controlling the current path of a transistor turned on/off in a standby mode.

In accordance with an exemplary embodiment of the present invention, an integrated circuit includes a first driving unit configured to drive an output terminal to a first power supply voltage in response to an active mode signal, a second driving unit configured to drive the output terminal to a second power supply voltage in response to a standby mode signal, and a current control unit configured to control the current path between the first driving unit and the first power supply voltage terminal in response to a mode control signal denoting the active mode signal and the standby mode signal.

In accordance with another exemplary embodiment of the present invention, an integrated circuit includes a first driving unit configured to drive an output terminal to a first power supply voltage in response to an active mode signal, a second driving unit configured to drive the output terminal to a second power supply voltage in response to a standby mode signal, and a current control unit configured to couple the first power supply voltage to the first driving unit in response to a mode control signal denoting the active mode signal and to decouple the first power supply voltage from the first driving unit in response to a mode control signal denoting the standby mode signal.

In accordance with yet another exemplary embodiment of the present invention, an integrated circuit includes a first driving unit configured to drive an output terminal to a first power supply voltage in response to an active mode signal, a second driving unit configured to drive the output terminal to a second power supply voltage in response to a standby mode signal, and a current control unit configured to control a voltage difference between the first power supply voltage and the voltage applied on the output terminal in response to the standby mode signal.

In accordance with still another exemplary embodiment of the present invention, an integrated circuit includes a first driving unit configured to drive an output terminal to a first power supply voltage in response to an input signal, a second driving unit configured to drive the output terminal to a second power supply voltage in response to the input signal, and a control unit connected between the first driving unit and the first power supply voltage terminal and configured to control the voltage applied to the first driving unit in response to a control signal corresponding to the input signal.

The integrated circuits in accordance with the exemplary embodiments of the present invention may reduce an off-current from being generated therein, by controlling the current path of a transistor turned on/off in a standby mode.

### BRIEF DESCRIPTION OF THE DRAWINGS

FIG. 1 is a circuit diagram illustrating a known integrated circuit for generating a mode control signal.

FIG. 2 is a diagram illustrating an integrated circuit in accordance with an exemplary embodiment of the present invention.

FIG. 3 is a circuit diagram illustrating an integrated circuit having a current control unit in accordance with a first exemplary embodiment of the present invention.

FIG. 4 is a waveform diagram illustrating the operation waveforms of an input signal CTR_IN and a mode control signal CTR_MOD illustrated in FIG. 3.

FIG. 5 is a circuit diagram illustrating an integrated circuit having a current control unit in accordance with a second exemplary embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

FIG. 2 is a diagram illustrating an integrated circuit in accordance with an exemplary embodiment of the present invention.

Referring to FIG. 2, an integrated circuit includes a plurality of signal driving units 210, 220, 230 and 240 connected in cascade. Hereinafter, for convenience in description, the signal driving unit 210 among the signal driving units 210, 220, 230 and 240 will be representatively described. An input signal CTR_IN has a logic level corresponding to an active mode or a standby mode. For example, the input signal CTR_IN has a logic high level in an active mode and has a logic low level in a standby mode.

The signal driving unit 210 includes a first PMOS transistor P1, a first NMOS transistor N1, and a current control unit 211. The first PMOS transistor P1 and the first NMOS transistor N1 operate as a driving unit. The first PMOS transistor P1 and the first NMOS transistor N1 are configured to drive a node A (i.e., an output terminal) in response to the input signal CTR_IN. The first PMOS transistor P1 is configured to pull-up drive the node A to a power supply voltage VDD in response to the input signal CTR_IN. The first NMOS transistor N1 is configured to pull-down drive the node A to a ground voltage VSS in response to the input signal CTR_IN. The current control unit 211 is configured to control the current path between the first NMOS transistor N1 and the ground voltage (VSS) terminal in response to a mode control signal CTR_MOD corresponding to an active mode or a standby mode. That is, the voltage level of a source terminal B, e.g., a power terminal, of the first NMOS transistor N1 is controlled by the current control unit 211.

Since the integrated circuit in accordance with the exemplary embodiment of the present invention can control the current path between the first NMOS transistor N1 and the ground voltage (VSS) terminal according to an active mode or a standby mode, an off-current generated in the integrated circuit in a standby mode may be reduced. In a standby mode, the voltage level of the node B is controlled by the current control unit 211, and thus the voltage level difference between the node A and the node B may decrease in comparison to that of a circuitry having the known configuration. A decrease in the voltage level difference between the node A and the node B means a decrease in the amount of a current consumed in a standby mode.

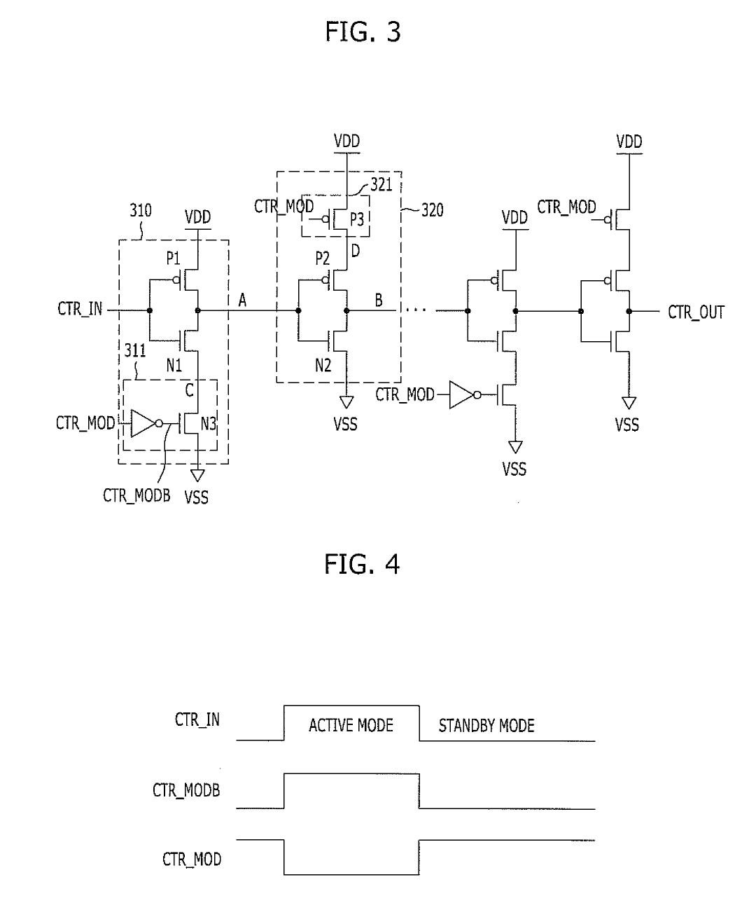

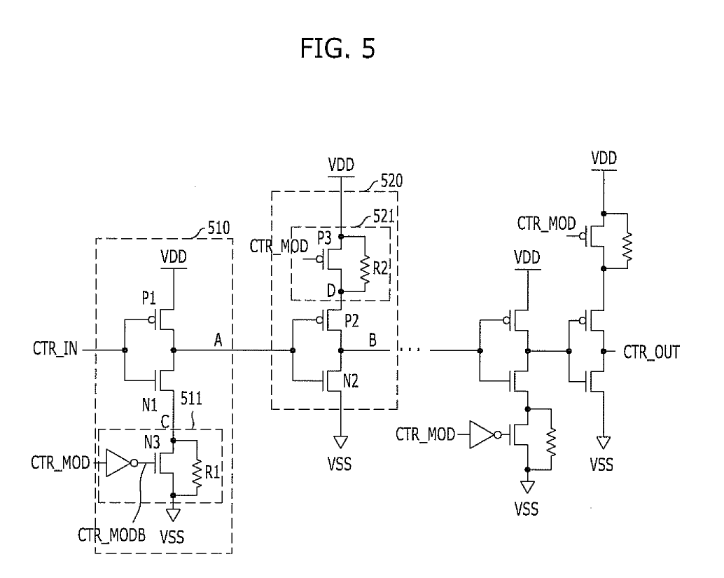

Hereinafter, a first exemplary embodiment and a second embodiment of the present invention will be described with reference to FIGS. 3 and 5.

FIG. 3 is a circuit diagram illustrating an integrated circuit having a current control unit in accordance with a first exemplary embodiment of the present invention.

For the sake of convenience, a signal driving unit 310 and a signal driving unit 320 among a plurality of signal driving units provided in the integrated circuit will be representatively described hereinafter.

Referring to FIG. 3, the signal driving unit 310 includes a first PMOS transistor P1, a first NMOS transistor N1, and a first current control unit 311. The current control unit 311 is configured to couple a ground voltage VSS to the first NMOS transistor N1 in an active mode and decouple the ground voltage VSS from the first NMOS transistor N1 in a standby mode. The first power current control circuit 311 includes a third NMOS transistor N3. The third NMOS transistor N3 has a source-drain path connected between the ground voltage (VSS) terminal and the first NMOS transistor N1, and a gate configured to receive an inversion signal CTR_MODB of a mode control signal CTR_MOD.

The signal driving unit 320 includes a second PMOS transistor P1, a second NMOS transistor N2, and a second current control unit 321. The second current control unit 321 is configured to couple a power supply voltage VDD to the second PMOS transistor P2 in response to an active mode signal and decouple the power supply voltage VDD from the second PMOS transistor P2 in response to a standby mode signal. The second current control unit 321 includes a third PMOS transistor P3. The third PMOS transistor P3 has a source-drain path connected between the power supply voltage (VDD) terminal and the second PMOS transistor P2, and a gate configured to receive the mode control signal CTR_MOD.

Before describing an operation of the circuit of FIG. 3, an operation waveform of the input signal CTR_IN and an operation waveform of the mode control signal CTR_MDd will be described with reference to FIG. 4.

FIG. 4 is a waveform diagram illustrating an operation waveform of the input signal CTR_IN and an operation waveform of the mode control signal CTR_MOD.

Referring to FIG. 4, the input signal CTR_IN is a pulse signal that is activated to a logic high level in an active mode and is deactivated to a logic low level in a standby mode. The mode control signal CTR_MOD is a pulse signal that is deactivated to a logic low level in an active mode and is activated to a logic high level in a standby mode. A mode control bar signal CTR_MODB is an inverted pulse signal of the mode control signal CTR_MOD.

Hereinafter, an operation of the integrated circuit having a current control unit in accordance with the first exemplary embodiment of the present invention will be described with reference to FIGS. 3 and 4.

In an active mode, that is, when the input signal CTR_IN is in a logic high level, the first NMOS transistor N1 is turned on. In this case, an inversion signal CTR_MODB of the mode control signal CTR_MOD is in a logic high level, and the third NMOS transistor N3 is turned on in response thereto. Accordingly, the first NMOS transistor N1 receives the ground voltage VSS through the third NMOS transistor N3, and the node A is driven to the ground voltage VSS. The second PMOS transistor P2 is turned on by the node A driven to the ground voltage VSS. In this case, the mode control signal CTR_MOD is in a logic low level, and thus the third PMOS transistor P3 is turned on. Accordingly, the second PMOS transistor P2 receives the power supply voltage VDD through the third PMOS transistor P3, and the node B is driven to the power supply voltage VDD. Consequently, the output signal CTR_OUT becomes a logic high level in response to the input signal CTR_IN of a logic high level.

In a standby mode, that is, when the input signal CTR_IN is in a logic low level, the first PMOS transistor P1 is turned on and the node A is driven to the power supply voltage VDD. In this case, the inversion signal CTR_MODB of the mode control signal CTR_MOD is in a logic low level, and the third NMOS transistor N3 is turned off. That is, the first NMOS transistor N1 and the ground voltage (VSS) terminal are electrically disconnected from each other. The second NMOS transistor N2 is turned on by the node A driven to the power supply voltage VDD, and the node B is driven to the ground voltage VSS. In this case, the mode control signal CTR_MOD is in a logic low level, and the third PMOS transistor P3 is turned off. That is, the second PMOS transistor P2 and the power supply voltage (VDD) terminal are electrically disconnected from each other. Consequently, the output signal CTR_OUT becomes a logic low level in response to the input signal CTR_IN of a low logic level.

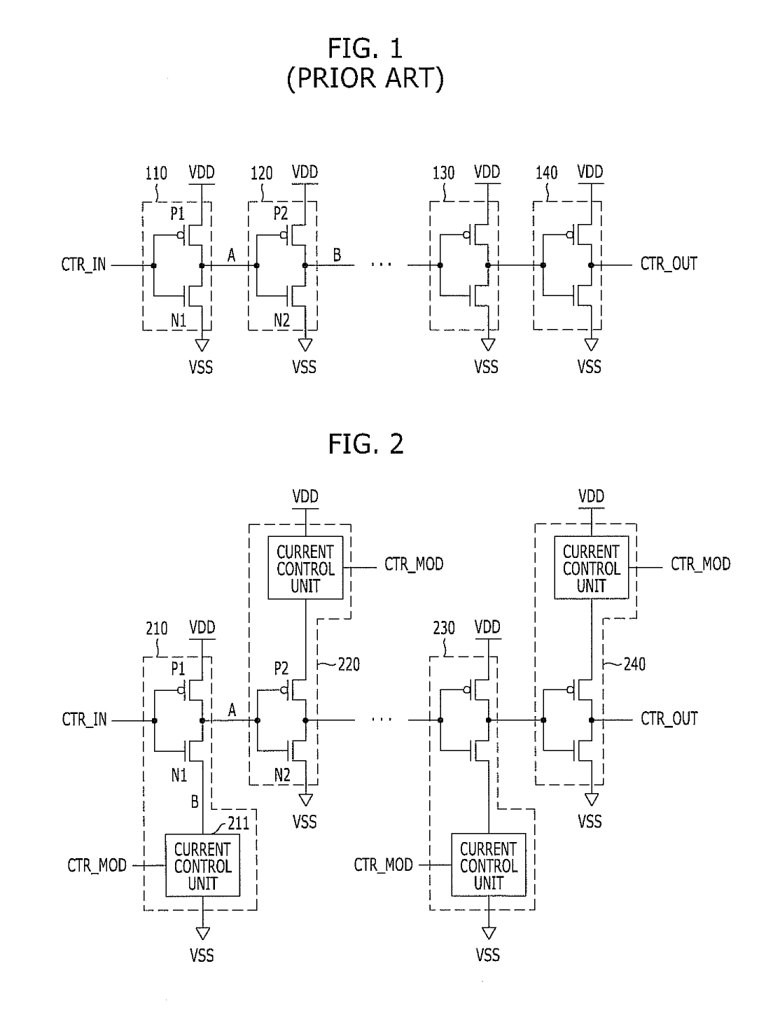

In the case of the known circuit configuration illustrated in FIG. 1, in a standby mode, the node A is driven to the power supply voltage VDD and the ground voltage VSS is applied to the source terminal of the turned-off first NMOS transistor N1. Thus, an off-current is generated at the first NMOS transistor N1 due to the voltage difference between both ends thereof. However, in the case of the integrated circuit having a current control circuit according to the first exemplary embodiment of the present invention, in a standby mode, the node A is driven to the power supply voltage VDD but the node C has a higher voltage level than the ground voltage VSS due to the turned-off third NMOS transistor N3. That is, the voltage level difference between the node A and the node C is smaller than the voltage level difference between the power supply voltage VDD and the ground voltage VSS. Consequently, the amount of an off-current generated in the first NMOS transistor N1 in a standby mode may be less than that of the known configuration. This may also be true with regards to the second PMOS transistor P2.

Meanwhile, various attempts have been made to increase the operation speed of a circuit. As an example, a short channel transistor may be used to increase the operation speed of a circuit. The short channel transistor has a high operation speed but has a large off-current flowing therein. In the case of the first embodiment of FIG. 3, short channel transistors may be used to configure the third NMOS transistor N3 and the third PMOS transistor P3 in order to secure a high operation speed in an active mode. However, while such a configuration can provide a high-speed operation, it also may generate an off-current in a standby mode, albeit an off-current smaller than that of the known configuration. Hereinafter, a description will be given of an integrated circuit that is better suited for use in a high-speed operation mode.

FIG. 5 is a circuit diagram illustrating an integrated circuit having a current control circuit in accordance with a second exemplary embodiment of the present invention.

For the sake of convenience, a signal driving unit 510 and a signal driving unit 520 among a plurality of signal driving units provided in the integrated circuit will be representatively described hereinafter.

Referring to FIG. 5, the signal driving unit 510 includes a first PMOS transistor P1, a first NMOS transistor N1, and a first current control unit 511. The first current control unit 511 includes a third NMOS transistor N3 and a first resistor R1.

The first current control unit 511 performs the same active mode operation as the first exemplary embodiment of FIG. 3 in response to the mode control signal CTR_MOD, or controls a voltage of the node C in a standby mode. In response to the mode control signal CTR_MOD, the third NMOS transistor N3 couples the ground voltage VSS to the first NMOS transistor N1, or decouples the ground voltage VSS from the first NMOS transistor N1. That is, the third NMOS transistor N3 operates to couple the ground voltage VSS to the first NMOS transistor N1 in response to an active mode signal, and to decouple the ground voltage VSS from the first NMOS transistor N1 in response to a standby mode signal. In response to a standby mode signal, the first resistor R1 provides a predetermined resistance between the node C and the ground voltage (VSS) terminal.

The signal driving unit 520 includes a second PMOS transistor P2, a second NMOS transistor N2, and a second current control unit 521. The second current control unit 521 includes a third PMOS transistor P3 and a second resistor R2. The second current control unit 521 performs an active mode operation in response to the mode control signal CTR_MOD, or controls a voltage of the node Din the standby mode.

Hereinafter, an operation of the integrated circuit having a current control circuit in accordance with the second exemplary embodiment of the present invention will be described with reference to FIG. 5.

In an active mode, that is, when the input signal CTR_IN is in a logic high level, the first NMOS transistor N1 is turned on. In this case, an inversion signal CTR_MODB of the mode control signal CTR_MOD is in a logic high level, and the third NMOS transistor N3 is turned on. Accordingly, the first NMOS transistor N1 receives the is ground voltage VSS through the third NMOS transistor N3, and the node A is driven to the ground voltage VSS. The second PMOS transistor P2 is turned on by the node A driven to the ground voltage VSS. In this case, the mode control signal CTR_MOD is in a logic low level, and the third PMOS transistor P3 is turned on. Accordingly, the second PMOS transistor P2 receives the power supply voltage VDD through the third PMOS transistor P3, and the node B is driven to the power supply voltage VDD. Consequently, the output signal CTR_OUT becomes a logic high level in response to the high-level input signal CTR_IN.

In a standby mode, that is, when the input signal CTR_IN is in a logic low level, the first PMOS transistor P1 is turned on and the node A is driven to the power supply voltage VDD. In this case, the inversion signal CTR_MODB of the mode control signal CTR_MOD is in a logic low level, and the third NMOS transistor N3 is turned off. That is, the first NMOS transistor N1 and the ground voltage (VSS) terminal are electrically disconnected from each other, and the resistance of the first resistor R1, which is provided between the ground voltage (VSS) terminal and the first NMOS transistor N1, adjusts the voltage at node C. The second NMOS transistor N2 is turned on by the node A driven to the power supply voltage VDD, and the node B is driven to the ground voltage VSS. In this case, the mode control signal CTR_MOD is in a logic low level, and the third PMOS transistor P3 is turned off. That is, the second PMOS transistor P2 and the power supply voltage (VDD) terminal are electrically disconnected from each other, and the resistance of the second resistor R2, which is provided between the power supply voltage (VDD) terminal and the second PMOS transistor P2, adjusts the voltage at node D. Consequently, the output signal CTR_OUT becomes a logic low level in response to the low-level input signal CTR_IN.

In the case of the known circuit configuration illustrated in FIG. 1, in a standby mode, the node A is driven to the power supply voltage VDD and the ground voltage VSS is applied to the source terminal of the turned-off first NMOS transistor N1. Thus, an off-current is generated at the first NMOS transistor N1 due to the voltage difference between both ends thereof. However, in the case of the integrated circuit having a current control circuit according to the second exemplary embodiment of the present invention, in a standby mode, the node A is driven to the power supply voltage VDD but the node C has a higher voltage level than the ground voltage VSS due to the first resistor R1. Also, the node B is driven to the ground voltage VSS but the node D has a lower voltage level than the power supply voltage VDD due to the second resistor R2.

That is, in a standby mode, voltage level differences between the nodes A and C and between the nodes B and D are smaller than the voltage level difference between the power supply voltage VDD and the ground voltage VSS. Accordingly, the amount of an off-current generated in the first NMOS transistor N1 and the second PMOS transistor P2 in a standby mode may decrease in comparison to that of the known configuration. For reference, the second exemplary embodiment may be implemented in the case of using short channel transistors. This means that the second exemplary embodiment may provide a high-speed operation in an active mode and may minimize an off-current consumed in a standby mode.

Although the description above describes configurations for reducing an off-current in a standby mode, it is also applicable to configurations for reducing an off current in an active mode. In addition, the positions and types of the logic gates and transistors used herein may be varied depending on polarities of the input signals.

As described above, the present invention prevents an off current from being generated in the integrated circuit in a standby mode, thereby making it possible to minimize the amount of a current consumed in the integrated circuit in a standby mode.

While the present invention has been described with respect to the specific embodiments, it will be apparent to those skilled in the art that various changes and modifications may be made without departing from the spirit and scope of the invention as defined in the following claims.

What is claimed is:

1. An integrated circuit comprising:
a first driving unit configured to drive an output terminal to a first power supply voltage in response to an active mode signal;
a second driving unit configured to drive the output terminal to a second power supply voltage in response to a standby mode signal; and
a current control unit configured to control the current path between the first driving unit and the first power supply voltage terminal in response to a mode control signal denoting the active mode signal or standby mode signal.

2. The integrated circuit of claim 1, wherein the current control unit controls a voltage level of a power supply terminal of the first driving unit in response to the mode control signal.

3. The integrated circuit of claim 1, wherein the first driving unit is configured to pull-down drive the output terminal to a ground voltage and the second driving unit is configured to pull-up drive the output terminal to a power supply voltage.

4. The integrated circuit of claim 1, wherein the first driving unit is configured to pull-up drive the output terminal to a power supply voltage, and the second driving unit is configured to pull-down drive the output terminal to a ground voltage.

5. An integrated circuit comprising:
a first driving unit configured to drive an output terminal to a first power supply voltage in response to an active mode signal;
a second driving unit configured to drive the output terminal to a second power supply voltage in response to a standby mode signal; and
a current control unit configured to couple the first power supply voltage to the first driving unit in response to a mode control signal denoting the active mode signal and to decouple the first power supply voltage from the first driving unit in response to a mode control signal denoting the standby mode signal.

6. The integrated circuit of claim 5, wherein the current control unit comprises a MOS transistor connected between the first power supply voltage terminal and the first driving unit and configured to couple or to decouple the first power supply voltage to or from the first driving unit in response to the mode control signal.

7. The integrated circuit of claim 5, wherein the current control unit controls a voltage level of a power supply terminal of the first driving unit in response to the mode control signal.

8. The integrated circuit of claim 5, wherein the first driving unit is configured to pull-down drive the output terminal to a ground voltage and the second driving unit is configured to pull-up drive the output terminal to a power supply voltage.

9. The integrated circuit of claim 5, wherein the first driving unit is configured to pull-up drive the output terminal to a power supply voltage, and the second driving unit is configured to pull-down drive the output terminal to a ground voltage.

10. An integrated circuit comprising:
a first driving unit configured to drive an output terminal to a first power supply voltage in response to an active mode signal;
a second driving unit configured to drive the output terminal to a second power supply voltage in response to a standby mode signal; and
a current control unit configured to control a voltage difference between the first power supply voltage and the voltage applied on the output terminal in response to the standby mode signal.

11. The integrated circuit of claim 10, wherein the current control unit is configured to couple the first power supply voltage to the first driving unit in the active mode.

12. The integrated circuit of claim 10, wherein the current control unit comprises:
a MOS transistor configured to couple the first power supply voltage to the first driving unit in response to the active mode signal and decouple the first power supply voltage from the first driving unit in response to the standby mode signal; and
a resistor unit configured to provide a predetermined resistance between the first driving unit and a power supply terminal in response to the standby mode signal.

13. The integrated circuit of claim 10, wherein the current control unit controls a voltage level of a power supply terminal of the first driving unit in response to the active mode signal and the standby mode signal.

14. The integrated circuit of claim 10, wherein the first driving unit is configured to pull-down drive the output terminal to a ground voltage and the second driving unit is configured to pull-up drive the output terminal to a power supply voltage.

15. The integrated circuit of claim 10, wherein the first driving unit pull-up drives the output terminal to a power supply voltage, and the second driving unit pull-down drives the output terminal to a ground voltage.

16. An integrated circuit comprising:
a first driving unit configured to drive an output terminal to a first power supply voltage in response to an input signal;
a second driving unit configured to drive the output terminal to a second power supply voltage in response to the input signal; and
a control unit connected between the first driving unit and the first power supply voltage terminal and configured to control the voltage applied to the first driving unit in response to a control signal corresponding to the input signal.

17. The integrated circuit of claim 16, wherein when the first driving unit is enabled, the control unit is enabled to couple the first power supply voltage to the first driving unit, and when the second driving unit is enabled, the control unit is disabled.

18. The integrated circuit of claim 16, wherein when the control unit is disabled, the control unit decouples the first driving unit from the first power supply voltage terminal.

19. The integrated circuit of claim 16, wherein when the control unit is disabled, the control unit provides a predetermined resistance between the first driving unit and the first power supply voltage terminal.

20. The integrated circuit of claim 16, wherein the input signal and the control signal include a standby mode signal and an active mode signal.
